(19) United States
(12) Patent Application Publication
(10) Pub. No.: US 2024/0364848 A1
(43) Pub. Date: Oct. 31, 2024

(54) CONTROL DEVICE, IMAGING CONTROL SYSTEM, CONTROL METHOD, AND CONTROL PROGRAM

(71) Applicant: FUJIFILM Corporation, Tokyo (JP)

(72) Inventors: Tomoharu SHIMADA, Saitama-shi (JP); Tetsuya FUJIKAWA, Saitama-shi (JP)

(73) Assignee: FUJIFILM Corporation, Tokyo (JP)

(21) Appl. No.: 18/767,928

(22) Filed: Jul. 9, 2024

Related U.S. Application Data
(63) Continuation of application No. PCT/JP2023/001715, filed on Jan. 20, 2023.

(30) Foreign Application Priority Data
Jan. 31, 2022 (JP) 2022-013396

(51) Int. Cl. H04N 7/18; G06T 11/00; H04N 23/66; H04N 23/695

(52) U.S. Cl. CPC H04N 7/183; G06T 11/00; H04N 23/66; H04N 23/695

(57) ABSTRACT

A control device includes a processor. The processor is configured to: combine a plurality of pieces of image data obtained by imaging performed by an imaging apparatus whose imaging direction is changeable to generate second image data; generate third image data, which is different from the second image data, based on the second image data; output the third image data and first image data obtained by imaging performed by the imaging apparatus to a display; output the second image data to the display; and selectively perform first control of outputting the first image data and the third image data to the display and second control of outputting the second image data and the third image data to the display.

### CROSS REFERENCE TO RELATED APPLICATION

This is a continuation of International Application No. PCT/JP2023/001715 filed on Jan. 20, 2023, and claims priority from Japanese Patent Application No. 2022-013396 filed on Jan. 31, 2022, the entire disclosures of which are incorporated herein by reference.

### BACKGROUND OF THE INVENTION

### 1. Field of the Invention

The present invention relates to a control device, an imaging control system, a control method, and a computer-readable medium storing a control program.

### 2. Description of the Related Art

JP2017-034552A discloses an information processing apparatus that sets a restricted range of pan and tilt that can be performed by a general user for a network camera whose pan angle and tilt angle are changeable, the information processing apparatus including a setting unit that sets the restricted range of the network camera and a display control unit that displays a video received from the network camera, in which the display control unit displays, in a case where a visual field range of the received video includes a boundary of the restricted range set by the setting unit, a line segment representing the boundary of the restricted range in the received video in a superimposed manner.

JP2019-140566A discloses an information processing apparatus including an acquisition unit that acquires a first image captured via a first imaging unit whose imaging range is changeable and a second image captured via a second imaging unit whose imaging range is wider than that of the first imaging unit, and a display control unit that displays, in a case where the first and second images acquired by the acquisition unit are displayed on a display unit, the first image at a position corresponding to the second image based on the imaging range of the first imaging unit.

### SUMMARY OF THE INVENTION

A control device according to one embodiment of the technique of the present disclosure comprises a processor, in which the processor is configured to combine a plurality of pieces of image data obtained by imaging performed by an imaging apparatus whose imaging direction is changeable to generate second image data, generate third image data, which is different from the second image data, based on the second image data, and output the third image data and first image data obtained by imaging performed by the imaging apparatus to a display.

An imaging control system according to one embodiment of the technique of the present disclosure comprises the control device and the imaging apparatus.

A control method according to one embodiment of the technique of the present disclosure comprises combining a plurality of pieces of image data obtained by imaging performed by an imaging apparatus whose imaging direction is changeable to generate second image data, generating third image data, which is different from the second image data, based on the second image data, and outputting the third image data and first image data obtained by imaging performed by the imaging apparatus to a display.

A non-transitory computer-readable medium storing a control program according to one embodiment of the technique of the present disclosure causes a processor to execute steps of combining a plurality of pieces of image data obtained by imaging performed by an imaging apparatus whose imaging direction is changeable to generate second image data, generating third image data, which is different from the second image data, based on the second image data, and outputting the third image data and first image data obtained by imaging performed by the imaging apparatus to a display.

### BRIEF DESCRIPTION OF THE DRAWINGS

FIG. 1 is a schematic diagram showing a schematic configuration of an imaging control system 1.

FIG. 2 is a diagram showing an example of revolution of a surveillance camera 10 in a pitch direction by a revolution mechanism 16.

FIG. 3 is a diagram showing an example of the revolution of the surveillance camera 10 in a yaw direction by the revolution mechanism 16.

FIG. 4 is a block diagram showing an example of a configuration of an optical system and an electrical system of the surveillance camera 10.

FIG. 5 is a diagram showing an example of a configuration of an electrical system of the revolution mechanism 16 and a management apparatus 11.

FIG. 6 is a diagram schematically showing entire image data generated by a CPU 60A.

FIG. 7 is a schematic diagram for describing display control performed by the CPU 60A.

FIG. 8 is a diagram showing a state where a rectangular area S1 is moved from the state shown in FIG. 7.

FIG. 9 is a schematic diagram for describing the display control performed by the CPU 60A.

FIG. 10 is a schematic diagram for describing the display control performed by the CPU 60A.

FIG. 11 is a schematic diagram for describing the display control performed by the CPU 60A.

FIG. 12 is a schematic diagram for describing the display control performed by the CPU 60A.

FIG. 13 is a schematic diagram for describing the display control performed by the CPU 60A.

### DESCRIPTION OF THE PREFERRED EMBODIMENTS

Hereinafter, an imaging control system of an embodiment of the present invention will be described with reference to drawings.

### <Imaging Control System of Embodiment>

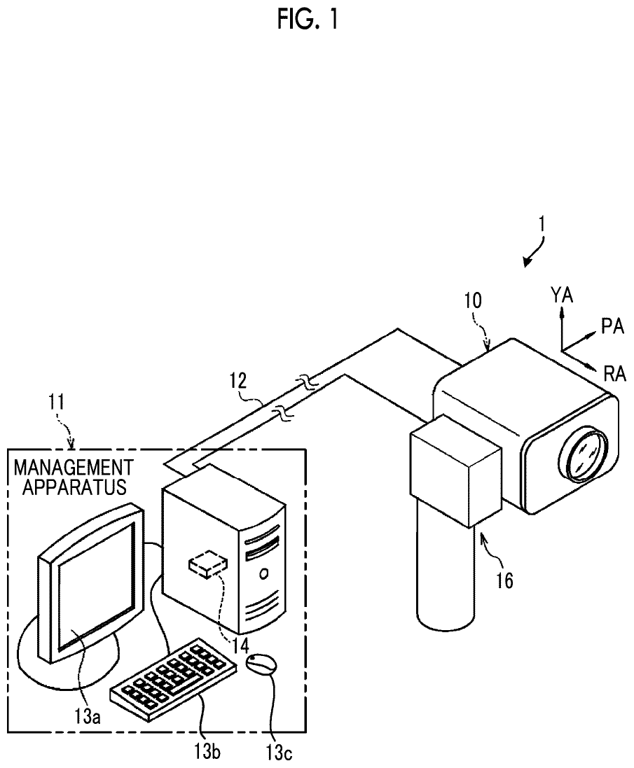

FIG. 1 is a schematic diagram showing a schematic configuration of an imaging control system 1. As shown in FIG. 1, the imaging control system 1 includes a surveillance camera 10, a revolution mechanism 16 that supports the surveillance camera 10 in a revolvable manner, and a management apparatus 11. The surveillance camera 10 and the revolution mechanism 16 constitute an imaging apparatus that can change an imaging direction. The management apparatus 11 constitutes a control device.

The surveillance camera 10 is installed in an indoor or outdoor post or wall, a part (for example, rooftop) of a building, or the like, via the revolution mechanism 16, to capture an imaging target that is a subject. The surveillance camera 10 transmits, to the management apparatus 11 via a communication line 12, image data obtained by capturing and imaging information related to the capturing of the image data.

The management apparatus 11 comprises a display 13a, a keyboard 13b, a mouse 13c, and a secondary storage device 14. Examples of the display 13a include a liquid crystal display, a plasma display, an organic electro-luminescence (EL) display, and a cathode ray tube (CRT) display.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The management apparatus 11 receives the image data or the imaging information, which is transmitted from the surveillance camera 10, and displays the received image data or imaging information on the display 13a or stores the received image data or imaging information in the secondary storage device 14.

The management apparatus 11 performs imaging control of controlling the imaging performed by the surveillance camera 10. For example, the management apparatus 11 communicates with the surveillance camera 10 via the communication line 12 to perform the imaging control. The imaging control is to set, in the surveillance camera 10, imaging parameters (exposure, shutter speed, frame rate, resolution, zoom magnification, and the like) for imaging performed by the surveillance camera 10 and cause the surveillance camera 10 to execute the imaging.

### <Revolution of Surveillance Camera 10 by Revolution Mechanism 16>

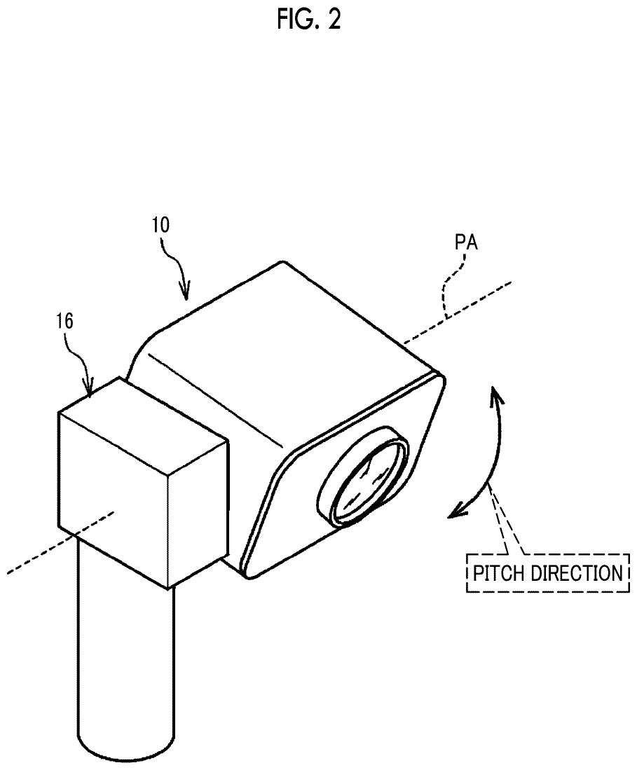

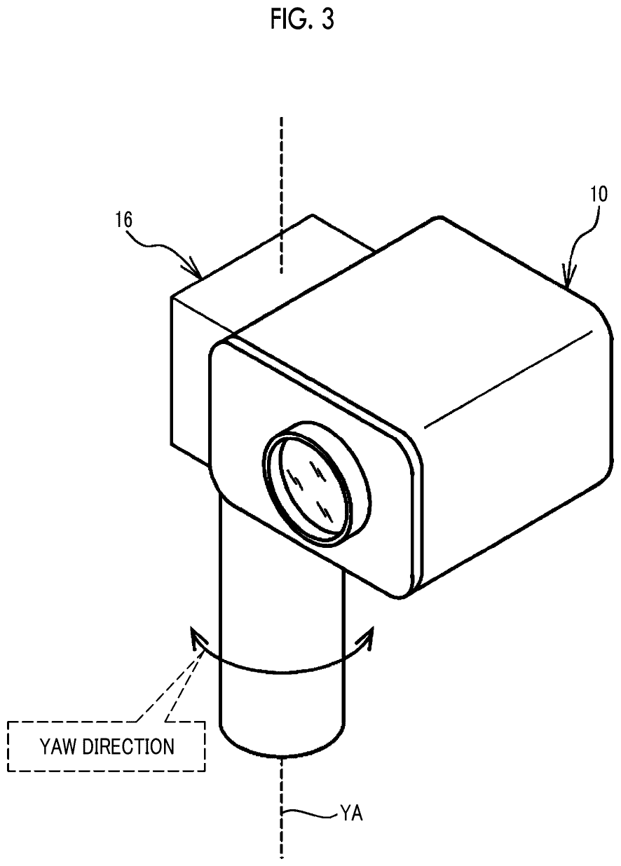

FIG. 2 is a diagram showing an example of revolution of the surveillance camera 10 in a pitch direction by the revolution mechanism 16. FIG. 3 is a diagram showing an example of the revolution of the surveillance camera 10 in a yaw direction by the revolution mechanism 16. The surveillance camera 10 is attached to the revolution mechanism 16. The revolution mechanism 16 enables the surveillance camera 10 to revolve.

Specifically, the revolution mechanism 16 is a two-axis revolution mechanism that enables the surveillance camera 10 to revolve in a revolution direction (pitch direction) that intersects the yaw direction and that has a pitch axis PA as a central axis, as shown in FIG. 2 as an example, and in a revolution direction (yaw direction) that has a yaw axis YA as a central axis, as shown in FIG. 3 as an example. An example is shown in which the two-axis revolution mechanism is used as the revolution mechanism 16 according to the present embodiment, but the present invention is not limited thereto. A three-axis revolution mechanism or a one-axis revolution mechanism may be used.

### <Configuration of Optical System and Electrical System of Surveillance Camera 10>

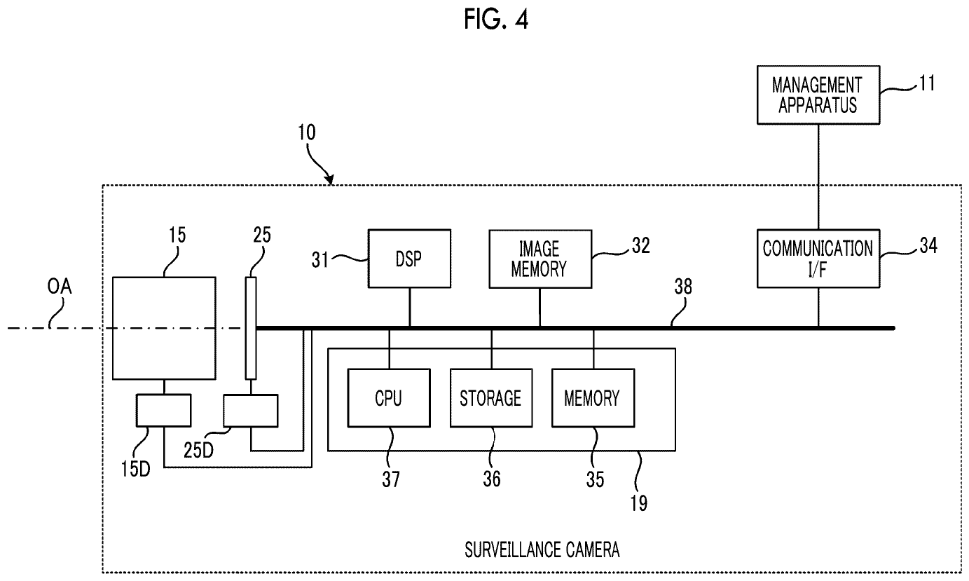

FIG. 4 is a block diagram showing an example of a configuration of an optical system and an electrical system of the surveillance camera 10. As shown in FIG. 4, the surveillance camera 10 comprises an imaging optical system 15 and an imaging element 25. The imaging element 25 is located after the imaging optical system 15. The imaging optical system 15 includes a zoom lens or the like. An increase in a focal length by the zoom lens sets the surveillance camera 10 on a telephoto side, and thus an imaging range is narrowed. A decrease in the focal length by the zoom lens sets the surveillance camera 10 on a wide angle side, and thus the imaging range is widened. The imaging optical system 15 according to the present embodiment is configured to include a plurality of imaging optical systems having different angles of view and to switch between the plurality of imaging optical systems. For example, the imaging optical system 15 is configured to include a standard optical system whose angle of view has a first value and a wide angle optical system whose angle of view is wider than the first value and to switch between the standard optical system and the wide angle optical system. The imaging optical system 15 may not be able to change the angle of view other than the change in the angle of view by the movement of the zoom lens.

The imaging optical system 15 forms an image of light indicating an imaging region on a light-receiving surface of the imaging element 25, and the imaging element 25 images the imaging region.

The surveillance camera 10 further comprises a computer 19, a digital signal processor (DSP) 31, an image memory 32, a communication I/F 34, an imaging element drive unit 25D, and an imaging optical system drive unit 15D. The computer 19 comprises a memory 35, a storage 36, and a central processing unit (CPU) 37.

The imaging element 25, the DSP 31, the image memory 32, the communication I/F 34, the memory 35, the storage 36, the CPU 37, the imaging element drive unit 25D, and the imaging optical system drive unit 15D are connected to a bus 38.

The memory 35 temporarily stores various types of information, and is used as a work memory. A random access memory (RAM) is exemplified as an example of the memory 35, but the present invention is not limited thereto. Another type of storage device may be used. The storage 36 stores various programs for the surveillance camera 10. The CPU 37 reads out various programs from the storage 36 and executes the readout various programs on the memory 35 to control the entire surveillance camera 10. An example of the storage 36 includes a flash memory, SSD, EEPROM, or HDD. Further, for example, various non-volatile memories such as a magnetoresistive memory and a ferroelectric memory may be used instead of the flash memory or together with the flash memory.

The imaging element 25 is a complementary metal oxide semiconductor (CMOS) image sensor, for example. The imaging element 25 images the subject at a predetermined frame rate under an instruction of the CPU 37. The term “predetermined frame rate” described herein refers to, for example, several tens of frames/second to several hundreds of frames/second.

Here, the CMOS image sensor is exemplified for description as an example of the imaging element 25, but the technique of the present disclosure is not limited thereto. A charge coupled device (CCD) image sensor may be employed as the imaging element 25.

The DSP 31 performs various types of digital signal processing on a digital image signal output from the imaging element 25 to generate the image data. For example, the various types of digital signal processing refer to demosaicing, noise removal processing, gradation correction processing, and color correction processing. The DSP 31 outputs the image data after the digital signal processing to the image memory 32 for each frame. The image memory 32 stores the image data from the DSP 31.

The communication I/F 34 is, for example, a network interface, and controls transmission of various types of information to and from the management apparatus 11 via a network. An example of the network includes a wide area network (WAN) such as the Internet or a public communication network.

### <Configuration of Electrical System of Revolution Mechanism 16 and Management Apparatus 11>

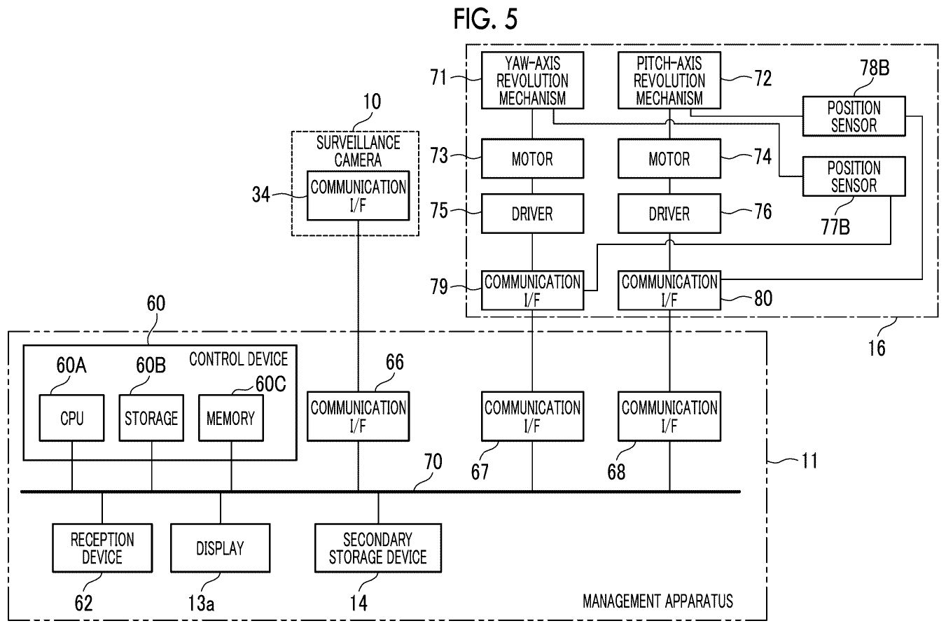

FIG. 5 is a diagram showing an example of a configuration of an electrical system of the revolution mechanism 16 and the management apparatus 11. As shown in FIG. 5, the revolution mechanism 16 comprises a yaw-axis revolution mechanism 71, a pitch-axis revolution mechanism 72, a motor 73, a motor 74, a driver 75, a driver 76, position sensors 77B and 78B, and communication IFs 79 and 80.

The yaw-axis revolution mechanism 71 causes the surveillance camera 10 to revolve in the yaw direction. The motor 73 is driven under the control of the driver 75 to generate power. The yaw-axis revolution mechanism 71 receives the power generated by the motor 73 to cause the surveillance camera 10 to revolve in the yaw direction. A rotation angle of the surveillance camera 10 in the yaw direction is also referred to as a pan angle. The pitch-axis revolution mechanism 72 causes the surveillance camera 10 to revolve in the pitch direction. The motor 74 is driven under the control of the driver 76 to generate the power. The pitch-axis revolution mechanism 72 receives the power generated by the motor 74 to cause the surveillance camera 10 to revolve in the pitch direction. The rotation angle of the surveillance camera 10 in the pitch direction is also referred to as a tilt angle.

The position sensor 77B detects a revolution position (pan angle) of the yaw-axis revolution mechanism 71. The position sensor 78B detects the revolution position (tilt angle) of the pitch-axis revolution mechanism 72.

The communication I/Fs 79 and 80 are, for example, network interfaces, and control transmission of various types of information to and from the management apparatus 11 via the network. An example of the network includes a wide area network (WAN) such as the Internet or a public communication network.

As shown in FIG. 5 as an example, the management apparatus 11 comprises the display 13a, the secondary storage device 14, a control device 60, a reception device 62, and communication I/Fs 66, 67, and 68. The control device 60 comprises a CPU 60A, a storage 60B, and a memory 60C. The CPU 60A is an example of a processor. In the present embodiment, the processor refers to a processor in a broad sense, and includes a general-purpose processor (for example, CPU), a dedicated processor (for example, GPU: graphics processing unit, ASIC: application specific integrated circuit, FPGA: field programmable gate array, programmable logic device, or the like). Further, the processor in the embodiment may be operated not only by one processor but also by cooperation of a plurality of processors provided at physically separated positions.

Each of the reception device 62, the display 13a, the secondary storage device 14, the CPU 60A, the storage 60B, the memory 60C, and the communication I/Fs 66, 67, and 68 is connected to a bus 70.

The memory 60C temporarily stores various types of information and is used as the work memory. An example of the memory 60C includes the RAM, but the present invention is not limited thereto. Another type of storage device may be employed. Various programs for the management apparatus 11 (hereinafter simply referred to as “programs for management apparatus”) are stored in the storage 60B.

The CPU 60A reads out the program for management apparatus from the storage 60B and executes the readout program for management apparatus on the memory 60C to control the entire management apparatus 11, the surveillance camera 10, and the revolution mechanism 16. The program for management apparatus includes a control program. The storage 60B is an example of a non-transitory storage medium that can be read by the processor. The program for management apparatus may be stored in a non-transitory storage medium of a server connected to a network, such as the Internet, and may be stored in the storage 60B by being downloaded from the server.

The communication I/F 66 is, for example, a network interface. The communication I/F 66 is communicably connected to the communication I/F 34 of the surveillance camera 10 via the network, and controls transmission of various types of information to and from the surveillance camera 10. The communication I/Fs 67 and 68 are, for example, network interfaces. The communication I/F 67 is communicably connected to the communication I/F 79 of the revolution mechanism 16 via the network, and controls transmission of various types of information to and from the yaw-axis revolution mechanism 71. The communication I/F 68 is communicably connected to the communication I/F 80 of the revolution mechanism 16 via the network, and controls transmission of various types of information to and from the pitch-axis revolution mechanism 72.

The CPU 60A receives the image data, the imaging information, and the like from the surveillance camera 10 via the communication I/F 66 and the communication I/F 34.

The CPU 60A acquires the revolution position information (pan angle information) from the position sensor 77B of the revolution mechanism 16 via the communication I/F 67 and the communication I/F 79. Further, the CPU 60A acquires the revolution position information (tilt angle information) from the position sensor 78B via the communication I/F 68 and the communication I/F 80.

The CPU 60A controls the driver 75 and the motor 73 of the revolution mechanism 16 via the communication I/F 67 and the communication I/F 79 to control a revolution operation of the yaw-axis revolution mechanism 71. Further, the CPU 60A controls the driver 76 and the motor 74 of the revolution mechanism 16 via the communication I/F 68 and the communication I/F 80 to control the revolution operation of the pitch-axis revolution mechanism 72.

The CPU 60A controls the surveillance camera 10 via the communication I/F 66 and the communication I/F 34 to cause the surveillance camera 10 to image the subject (hereinafter also referred to as surveillance region).

The reception device 62 is, for example, the keyboard 13b, the mouse 13c, and a touch panel of the display 13a, and receives various instructions from the user. The CPU 60A acquires various instructions received by the reception device 62 and operates in response to the acquired instructions. For example, in a case where the reception device 62 receives a processing content for at least one of the surveillance camera 10 or the revolution mechanism 16, the CPU 60A operates at least one of the surveillance camera 10 or the revolution mechanism 16 in accordance with an instruction content received by the reception device 62.

The display 13a displays various types of information under the control of the CPU 60A. Examples of the various types of information displayed on the display 13a include contents of various instructions received by the reception device 62 and the image data or imaging information received by the communication I/F 66. The CPU 60A causes the display 13a to display the contents of various instructions received by the reception device 62 and the image data or imaging information received by the communication I/F 66. The CPU 60A acquires the image data and outputs the image data to the display 13a to display the image data on the display 13a. The output of the image data to the display 13a means that a final transmission destination of the image data is the display 13a. That is, even in a case where the CPU 60A outputs the image data and the image data is input to the display 13a via another apparatus, the output is defined as the output of the image data to the display 13a.

The secondary storage device 14 is, for example, a non-volatile memory and stores various types of information under the control of the CPU 60A. An example of the various types of information stored in the secondary storage device 14 includes the image data or imaging information received by the communication I/F 66. The CPU 60A stores the image data or imaging information received by the communication I/F 66 in the secondary storage device 14.

### <Image Display Control by CPU 60A of Management Apparatus 11>

### (Generation of Entire Image Data)

The CPU 60A images the subject at respective revolution positions (specific pan and tilt angles) while causing the surveillance camera 10 to revolve and acquires, from the surveillance camera 10, an image data group consisting of a plurality of pieces of image data obtained by respective pieces of imaging. Each piece of the image data constituting the image data group is a still image, and is obtained by performing the imaging in a state where the imaging optical system 15 is used as the standard optical system and the zoom magnification is one in the present embodiment. The CPU 60A connects and combines respective pieces of the image data of the image data group to generate entire image data corresponding to the captured images of the entire surveillance region that can be imaged by the surveillance camera 10, and stores entire image data in the storage 60B.

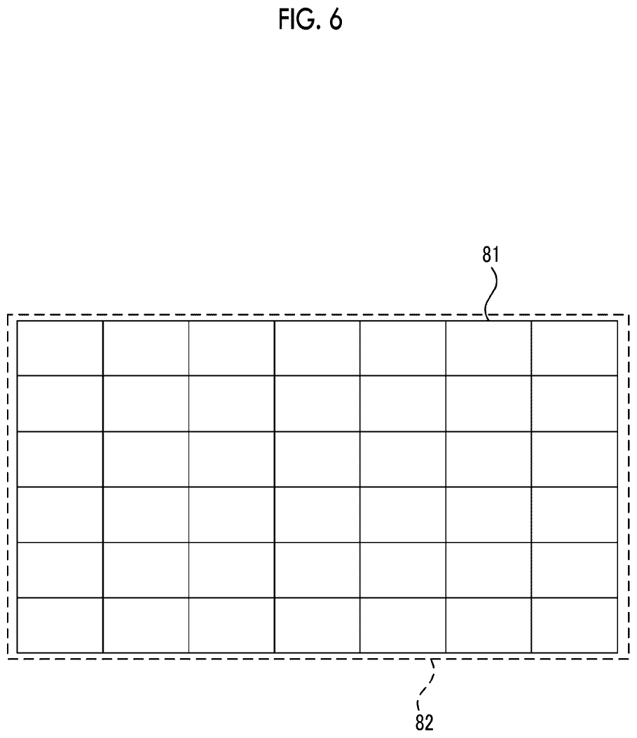

FIG. 6 is a diagram schematically showing the entire image data generated by the CPU 60A. FIG. 6 shows an example in which the CPU 60A acquires the image data group consisting of 42 pieces of image data 81 (blocks indicated by rectangles in FIG. 6) obtained by performing the imaging at respective positions of 42 revolution positions, which are decided by a combination of seven revolution positions in the yaw direction and six revolution positions in the pitch direction. The CPU 60A combines the 42 pieces of image data 81 to generate entire image data 82. In FIG. 6, for convenience, a broken line frame indicating an outer edge of the entire image data 82 is largely shown. The CPU 60A manages each pixel of the entire image data 82 and information on three-dimensional position coordinates of the entire surveillance region in association with each other. That is, a specific pixel in the entire image data 82 corresponds to a specific position of the entire surveillance region. The CPU 60A performs the processing of acquiring the image data group to generate the entire image data 82 at a predetermined timing (for example, a periodic timing such as once a day).

### (Display Control)

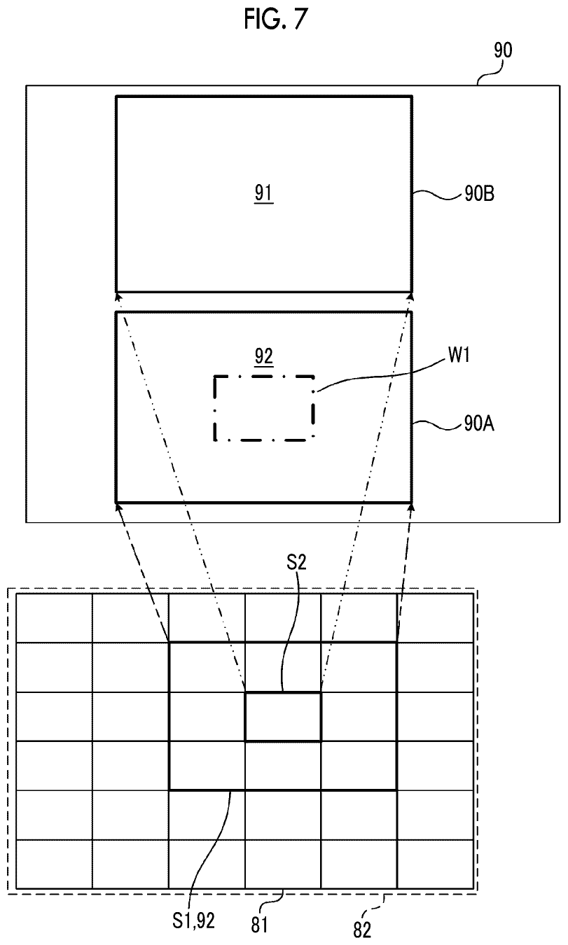

The CPU 60A performs display control of generating, from the entire image data 82, partial image data different from the entire image data 82, outputting the generated partial image data to the display 13a, and displaying the partial image data on the display 13a. FIG. 7 is a schematic diagram for describing the display control performed by the CPU 60A. FIG. 7 shows the entire image data 82 shown in FIG. 6 and an example of a display screen 90 of the display 13a. A display region 90A and a display region 90B having a predetermined size are set on the display screen 90, as display regions of the image data.

The CPU 60A sets, for the entire image data 82, a rectangular area S1 (area indicated by thick line frame in FIG. 7) smaller than a size of the entire image data 82 and extracts the image data in the set rectangular area S1 to set the extracted image data as partial image data 92. In the example in FIG. 7, the partial image data 92 is the image data configured of nine pieces of image data 81. The CPU 60A performs control of outputting the partial image data 92 to the display 13a to display the partial image data 92 in the display region 90A. An aspect ratio of the rectangular area S1 matches an aspect ratio of the display region 90A, and an outer edge of the partial image data 92 matches an outer edge of the display region 90A.

Further, the CPU 60A sets, for the partial image data 92, a rectangular area S2 having a predetermined position and a predetermined size, sets imaging conditions (imaging direction (pan and tilt angles), zoom magnification, angle of view (standard or wide angle), and the like) of the surveillance camera 10 based on the set rectangular area S2, and causes the surveillance camera 10 to image the subject. The CPU 60A acquires the image data (hereinafter referred to as real-time image data 91) obtained by the imaging from the surveillance camera 10 and outputs the acquired image data to the display 13a to display the real-time image data 91 in the display region 90B. The real-time image data 91 is preferably video data, but may be still image data. An aspect ratio of the rectangular area S2 matches an aspect ratio of the display region 90B, and an outer edge of the real-time image data 91 matches an outer edge of the display region 90B.

Although a size of the rectangular area S2 (defined by a combination of the number of horizontal pixels and the number of vertical pixels) is random, a specific example in a case where the size of the rectangular area S2 matches a size of the image data 81 will be described. First, the CPU 60A acquires three-dimensional position coordinates corresponding to a center pixel in the rectangular area S2 in the partial image data 92. The CPU 60A controls the revolution position of the revolution mechanism 16 such that an optical axis OA of the surveillance camera 10 intersects the acquired three-dimensional position coordinates, sets the zoom magnification of the surveillance camera 10 to one, and causes the surveillance camera 10 to image the subject with the imaging optical system 15 as the standard optical system. The CPU 60A displays the real-time image data 91 obtained by the imaging in the display region 90B. Accordingly, it is possible to display, in the display region 90B, a video obtained by imaging only the surveillance region corresponding to each pixel in the rectangular area S2 in the partial image data 92, as the real-time image data 91.

An operation example in a case where the size of the rectangular area S2 is smaller than the size of the image data 81 is as follows. Here, an example will be described in which the size of the rectangular area S2 is 0.8 times the size of the image data 81. First, the CPU 60A acquires three-dimensional position coordinates corresponding to a center pixel in the rectangular area S2 in the partial image data 92. The CPU 60A controls the revolution position of the revolution mechanism 16 such that the optical axis OA of the surveillance camera 10 intersects the acquired three-dimensional position coordinates. Further, the CPU 60A obtains a reciprocal number (1/0.8=1.25 in the present example) of the ratio (=0.8) of the size of the rectangular area S2 to the size of the image data 81, sets the zoom magnification of the surveillance camera 10 to the reciprocal magnification (1.25 times), and sets the imaging optical system 15 to the standard optical system. In this state, the surveillance camera 10 is caused to image the subject. The CPU 60A acquires the real-time image data 91 obtained by the imaging from the surveillance camera 10 and displays the real-time image data 91 in the display region 90B. Accordingly, even in a case where the size of the rectangular area S2 is smaller than the size of the image data 81, with the increase in the zoom magnification of the surveillance camera 10, it is possible to display, in the display region 90B, the video obtained by imaging only the surveillance region corresponding to each pixel in the rectangular area S2 as the real-time image data 91.

An operation example in a case where the size of the rectangular area S2 is larger than the size of the image data 81 is as follows. The CPU 60A switches the imaging optical system 15 to the wide angle optical system such that all positions corresponding to the pixels in the rectangular area S2 are included in the imaging range, sets the zoom magnification to one, and causes the surveillance camera 10 to image the subject. The CPU 60A acquires the real-time image data 91 obtained by the imaging from the surveillance camera 10 and displays the real-time image data 91 in the display region 90B. Even in a case where the size of the rectangular area S2 is larger than the size of the image data 81, with the switching of the imaging optical system 15 of the surveillance camera 10 from the standard optical system to the wide angle optical system, it is possible to display, in the display region 90B, a video obtained by imaging the surveillance region corresponding to each pixel in the rectangular area S2 as the real-time image data 91.

The CPU 60A performs the above display control at a time of activation of the imaging control system 1 to display the partial image data 92 and the real-time image data 91 as shown in FIG. 7. After the partial image data 92 and the real-time image data 91 are displayed, it is possible to change the position of the rectangular area S1 set for the entire image data 82 in response to an operation of the reception device 62.

In a case where the reception device 62 is operated and an instruction to move the rectangular area S1 is received in a state where the partial image data 92 and the real-time image data 91 are displayed, the CPU 60A moves the rectangular area S1 set for the entire image data 82.

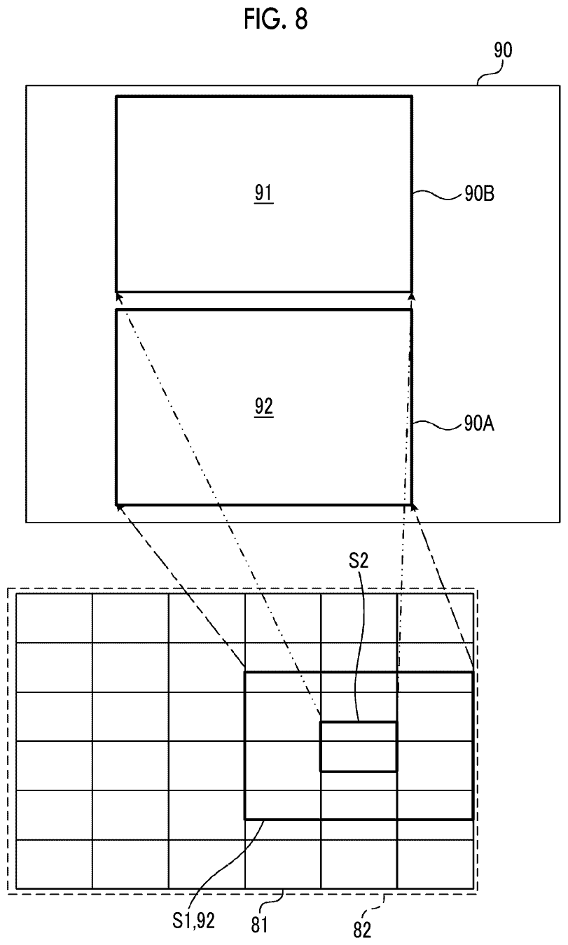

FIG. 8 is a diagram showing a state where the rectangular area S1 is moved in a right direction from the state shown in FIG. 7. In a case where the rectangular area S1 is moved, the CPU 60A generates the image data in the rectangular area S1 of a movement destination as new partial image data 92 and displays the new partial image data 92 in the display region 90A. Further, the CPU 60A sets the rectangular area S2 for the new partial image data 92, sets the imaging condition of the surveillance camera 10 based on the set rectangular area S2, and causes the surveillance camera 10 to image the subject. The CPU 60A acquires new real-time image data 91 obtained by the imaging from the surveillance camera 10 and displays the acquired real-time image data 91 in the display region 90B of the display 13a.

The rectangular area S2 can be set at any position as long as the position is within the partial image data 92. However, the rectangular area S2 is preferably set such that a center of the rectangular area S2 matches a center of the partial image data 92 as shown in FIG. 7. With the above, a vicinity of the center of the partial image data 92 displayed on the display 13a corresponds to the region imaged by the surveillance camera 10. Therefore, the user can intuitively understand the region imaged by the surveillance camera 10.

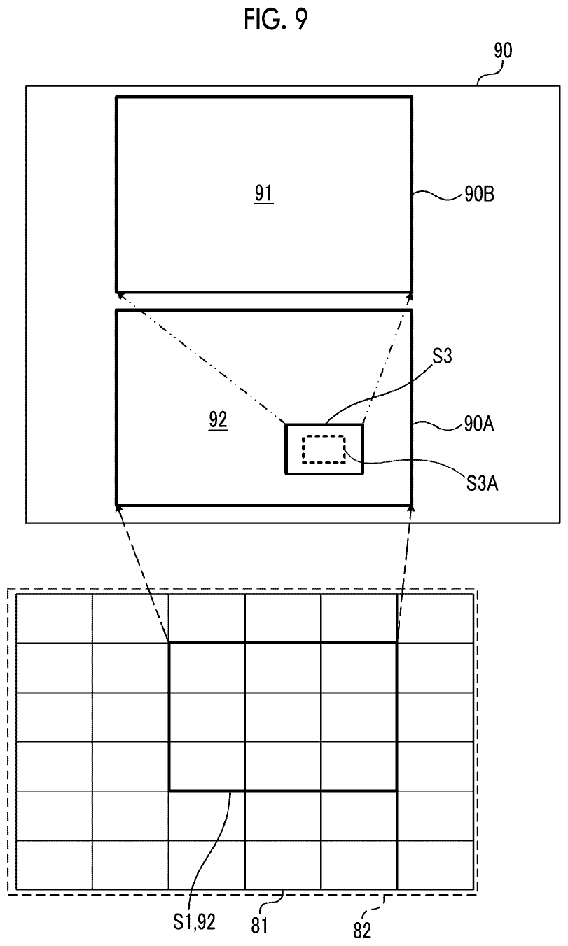

In a case where any rectangular area S3 is selected on the partial image data 92 by the operation of the reception device 62 as shown in FIG. 9 in a state where the partial image data 92 and the real-time image data 91 are displayed, the CPU 60A sets the imaging condition of the surveillance camera 10 such that a position corresponding to each pixel in the rectangular area S3 for the partial image data 92 is included in the imaging range, and causes the surveillance camera 10 to image the subject. The CPU 60A acquires the real-time image data 91 obtained by the imaging from the surveillance camera 10 and displays the real-time image data 91 in the display region 90B. With the above, it is possible for the surveillance camera 10 to image the surveillance region corresponding to any area for the partial image data 92 displayed on the display 13a, and it is possible to more flexibly change the imaging range of the surveillance camera 10.

In the state shown in FIG. 9, a case is assumed that a rectangular area S3A smaller than the rectangular area S3 whose center matches the rectangular area S3 is further selected. In this case, the CPU 60A increases the zoom magnification of the surveillance camera 10 such that only the position corresponding to each pixel in the rectangular area S3A falls within the imaging range. As described above, the change of the imaging condition based on the rectangular area S2 or the rectangular area S3 (S3A) includes a case where both the imaging direction and the focal length are changed and a case where only one of the imaging direction and the focal length is changed.

In a case where the movement of the rectangular area S1 is instructed by the operation of the reception device 62 from the state shown in FIG. 9, the CPU 60A preferably performs control of temporarily releasing the setting of the rectangular area S3 (S3A) and returning to the setting of the rectangular area S2. For example, in a case where the state in FIG. 9 transitions to the state in FIG. 8 with the movement of the rectangular area S1, the CPU 60A sets the rectangular area S2 for the partial image data 92, acquires the real-time image data 91 based on the rectangular area S2, and displays the real-time image data 91 in the display region 90B.

As described above, in the imaging control system 1, while checking a partial range of the entire surveillance region using the partial image data 92, it is possible to check a part of the range in detail using the real-time image data 91. For example, with the display of the entire image data 82, instead of the partial image data 92, in the display region 90A and the selection of a desired area from the entire image data 82, it is also possible to image the surveillance region corresponding to the area using the surveillance camera 10. Compared with the above configuration, with the imaging control system 1, even in the small display screen 90, it is possible to easily and accurately designate the range desired to be observed in the entire surveillance region, and it is possible to efficiently perform work to observe a small part of a wide surveillance region in detail.

### (First Modification Example of Control of CPU 60A)

The CPU 60A may control the position of the rectangular area S2 set for the partial image data 92 based on operating information of the revolution mechanism 16 instead of the fixed position. The operating information of the revolution mechanism 16 includes, for example, a revolution history of the revolution mechanism 16. The revolution history includes, for example, a holding time of the revolution position at each position in the entire surveillance region.

For example, the CPU 60A generates the partial image data 92, then acquires information about a cumulative time in which imaging is performed in a state where the optical axis OA intersects the position corresponding to the pixel of the partial image data 92, and sets the rectangular area S2 with a pixel corresponding to a position at which the cumulative time is longest, in the partial image data 92, as a center. With the above, it is possible to automatically display, in the display region 90B, the captured image in the range that is frequently observed by the user and it is possible to perform efficient display in accordance with a usage situation of the user.

### (Second Modification Example of Control of CPU 60A)

The CPU 60A may add information indicating the imaging condition of the real-time image data 91 being displayed to the partial image data 92 and output the information to the display 13a. For example, as shown in FIG. 7, the CPU 60A adds, to the partial image data 92, frame image data W1 indicating an outer edge of the rectangular area S2 corresponding to the imaging range of the real-time image data 91 and outputs, to the display 13a, the partial image data 92 and the frame image data W1 to display the partial image data 92 and the frame image data W1 in the display region 90A. With the above, it is possible to intuitively understand which range of the partial image data 92 is imaged to obtain the real-time image data 91.

Instead of the frame image data W1, the CPU 60A may generate an image (symbol or character) indicating a center position of the rectangular area S2, an image (symbol or character) indicating the zoom magnification of the surveillance camera 10, and an image (symbol or character) indicating the angle of view (standard or wide angle) of the surveillance camera 10, and add the generated images to the partial image data 92 to display the generated images. Even in such a case, it is possible to understand which range of the partial image data 92 is imaged.

### (Third Modification Example of Control of CPU 60A)

In a case where any rectangular area S3 is selected for the partial image data 92 and an operation of registering the information about the rectangular area S3 is performed, the CPU 60A stores the information about the rectangular area S1 and the information about the rectangular area S3, which are set at the point in time, in the memory 60C in association with each other. In a case where the rectangular area S1 is set for the entire image data 82 and the information of the rectangular area S3 corresponding to the set rectangular area S1 is present, the CPU 60A adds the information to the partial image data 92 extracted from the rectangular area S1 and outputs the information to the display 13a.

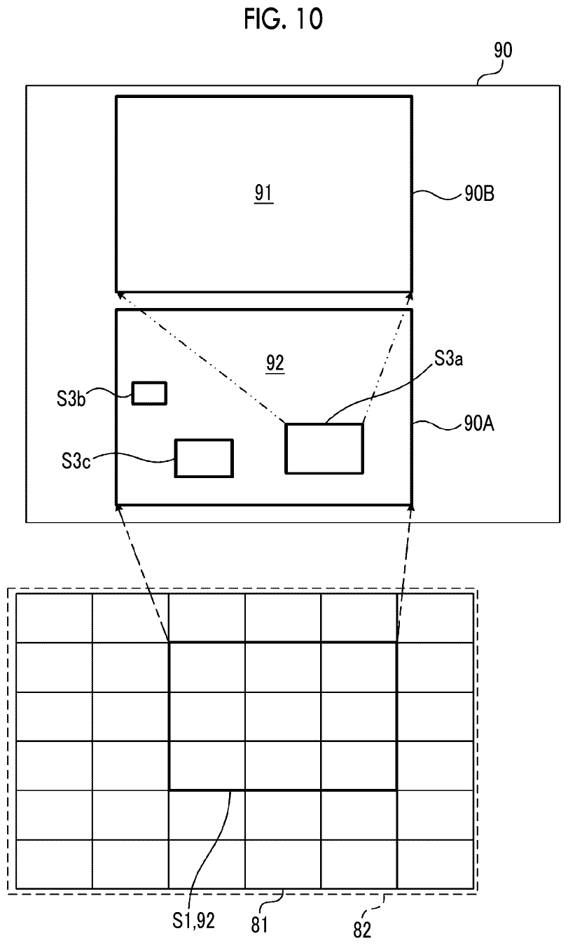

For example, a case is assumed that the operation of registering information of a rectangular area S3a, a rectangular area S3b, and a rectangular area S3c is performed for the entire image data 82 in a state where the rectangular area S1 shown in FIG. 10 is set. In this case, after the registration operation, in a case where the rectangular area S1 is at a position shown in FIG. 10, the CPU 60A displays information (frame image, symbol, character, or the like) indicating each of the registered rectangular area S3a, rectangular area S3b, and rectangular area S3c in a superimposed manner for the partial image data 92 in the rectangular area S1.

In this state, in a case where, for example, the information of the rectangular area S3a is selected by the operation of the reception device 62, the CPU 60A sets the rectangular area S3a for the partial image data 92, sets the imaging condition such that a position corresponding to each pixel in the rectangular area S3a falls within the imaging range, acquires the real-time image data 91 obtained under the imaging condition from the surveillance camera 10, and outputs the real-time image data 91 to the display 13a. Similarly, in a case where, for example, the information of the rectangular area S3b is selected by the operation of the reception device 62, the CPU 60A sets the rectangular area S3b for the partial image data 92, sets the imaging condition such that a position corresponding to each pixel in the rectangular area S3b falls within the imaging range, acquires the real-time image data 91 obtained under the imaging condition from the surveillance camera 10, and outputs the real-time image data 91 to the display 13a.

As described above, with registration of a range desired to be observed in advance in the surveillance region corresponding to the partial image data 92 and only selection of information indicating the range by the user, it is possible to check a video obtained by imaging the range using the real-time image data 91. According to this modification example, it is possible to make the operation of selecting the rectangular area for the partial image data 92 simple, and it is possible to efficiently perform work to observe a surveillance target.

### (Fourth Modification Example of Control of CPU 60A)

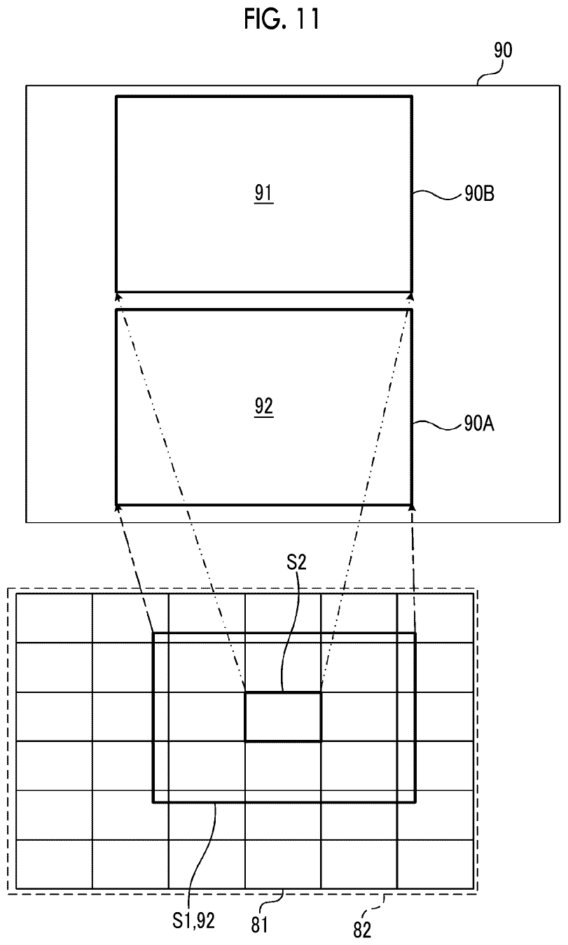

The size of the rectangular area S1 may be changed (enlarged or reduced) by the operation of the reception device 62 instead of being fixed. For example, in a case where an instruction to enlarge the rectangular area S1 is issued by the operation of the reception device 62 from the state shown in FIG. 7, the CPU 60A enlarges the rectangular area S1 while maintaining the aspect ratio as shown in FIG. 11, newly generates the image data in the rectangular area S1 after the enlargement as the partial image data 92, and displays the partial image data 92 in the display region 90A. Further, the CPU 60A sets the rectangular area S2 for the new partial image data 92 and controls the surveillance camera 10 and the revolution mechanism 16 such that a position corresponding to each pixel in the set rectangular area S2 falls within the imaging range to update the real-time image data 91 to be displayed in the display region 90B. As described above, it is possible to display, in the display region 90A, the partial image data 92 of a wider range centered on the currently checked partial image data 92 by the enlargement operation of the rectangular area S1, and it is possible to flexibly designate a range desired to be observed (range where the real-time image data 91 is desired to be acquired).

### (Fifth Modification Example of Control of CPU 60A)

In a case where an operation of changing the real-time image data 91 is performed by the reception device 62, the CPU 60A outputs, to the display 13a, the real-time image data 91 after the change and the partial image data 92 including a pixel corresponding to each position of the imaging range of the real-time image data 91. The operation of changing the real-time image data 91 corresponds to an operation of changing the imaging direction. In a case where this change operation is performed, the CPU 60A changes the imaging direction in a direction in response to the operation, acquires the real-time image data 91 from the surveillance camera 10, and outputs the real-time image data 91 to the display 13a to update the real-time image data 91 of the display region 90B. Further, the CPU 60A sets the rectangular area S1 such that the pixel corresponding to each position of the surveillance region included in the imaging range of the surveillance camera 10 after the change is included, and generates the image data in the rectangular area S1 of the entire image data 82 as the partial image data 92. The CPU 60A outputs the partial image data 92 to the display 13a to update the partial image data 92 of the display region 90A. As described above, with the change operation (imaging direction change) of the real-time image data 91, the rectangular area S1 can be moved in response to the change operation. Therefore, it is possible to increase a degree of freedom of changing the image as compared with a case where only the operation of moving the rectangular area S1 can be performed.

### (Sixth Modification Example of Control of CPU 60A)

The CPU 60A may selectively perform first control of outputting and displaying the real-time image data 91 and the partial image data 92 on the display 13a and second control of outputting and displaying the entire image data 82 and the partial image data 92 on the display 13a.

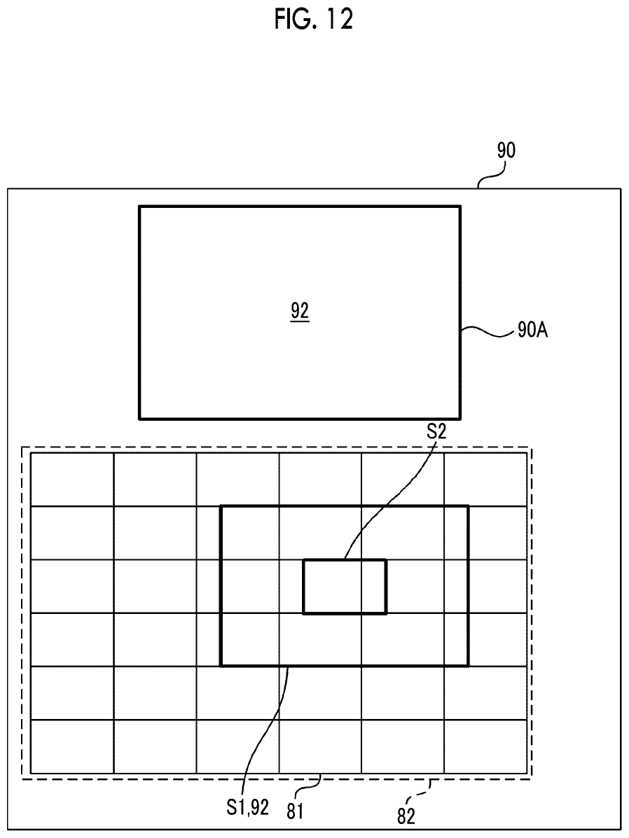

For example, in a case where the operation (operation of moving the rectangular area S1) of changing the partial image data 92 is performed in a state where the real-time image data 91 and the partial image data 92 are displayed as shown in FIG. 7, the CPU 60A performs control of displaying the partial image data 92 and the entire image data 82 on the display 13a as shown in FIG. 12. As shown in FIG. 12, frame images indicating the rectangular area S1 and the rectangular area S2 are preferably displayed in a superimposed manner on the entire image data 82. With the above, it is possible to decide a range in which the partial image data 92 is displayed while checking a correspondence relationship between the entire image data 82 and the partial image data 92 using the display screen 90, and it is possible to enhance convenience of use.

In a case where a state of performing the first control transitions to a state of performing the second control and the position of the rectangular area S1 is confirmed by the user, the CPU 60A preferably returns the control from the second control to the first control. Accordingly, with completion of the change of the partial image data 92, it is possible to return the display screen 90 to an original screen, and it is possible to enhance convenience of use. Further, the reception device 62 may be operated to switch between a mode in which the first control is performed and a mode in which the second control is performed. Accordingly, it is possible to properly use the display screen 90 according to the intention of the user. Further, in a case where a predetermined time elapses after the transition is made to the mode in which the second control is performed, the mode may be returned to the mode in which the first control is performed. Accordingly, the operation of returning the display screen 90 to the original position is not required, and it is possible to enhance convenience of use.

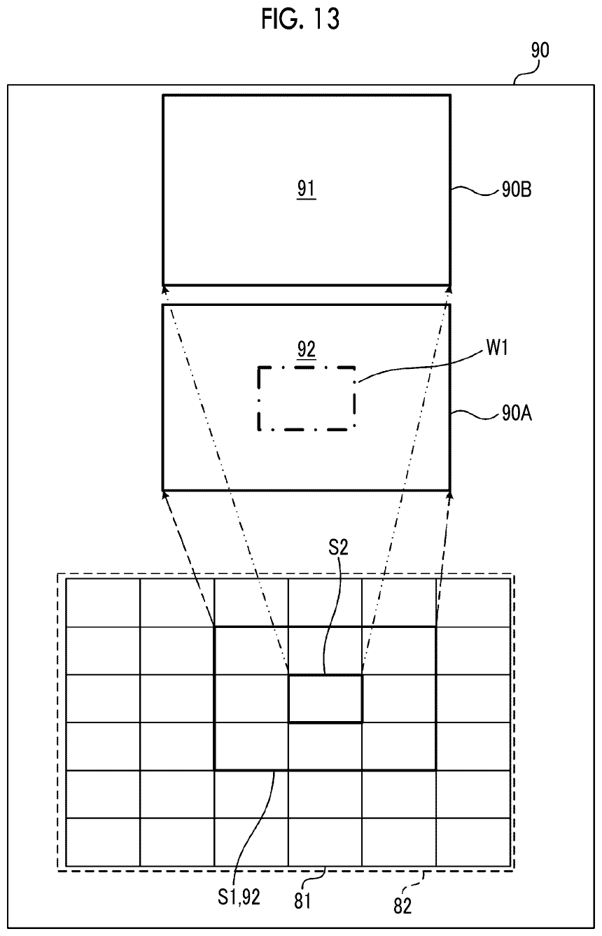

The CPU 60A may selectively perform third control of outputting and displaying the real-time image data 91, the partial image data 92, and the entire image data 82 on the display 13a as shown in FIG. 13 and the first control.

In the above description, while the zoom magnification of the surveillance camera 10 can be changed, the surveillance camera 10 may have a fixed focal length.

In the example in FIG. 1, FIG. 5, or the like, the configuration has been described in which the CPU 60A, the display 13a, and the reception device 62 are disposed at the same location.

However, these components may be disposed at different locations and may be connected to each other via a network.

As described above, at least the following matters are described in the present specification. Although the components and the like corresponding to the above embodiments are shown in parentheses, the present invention is not limited thereto.

(1)

A control device (control device 60) comprising:
a processor (CPU 60A),
wherein the processor is configured to:
combine a plurality of pieces of image data (image data 81) obtained by imaging performed by an imaging apparatus (surveillance camera 10 and revolution mechanism 16) whose imaging direction is changeable to generate second image data (entire image data 82);
generate third image data (partial image data 92), which is different from the second image data, based on the second image data; and
output the third image data and first image data (real-time image data 91) obtained by imaging performed by the imaging apparatus to a display (display 13a).
   (2)

The control device according to (1),
wherein the processor is configured to acquire the first image data, based on the third image data, and output the first image data to the display.
   (3)

The control device according to (1) or (2),
wherein the processor is configured to acquire, based on a first operation on the third image data displayed on the display, the first image data corresponding to the first operation and output the first image data to the display.
   (4)

The control device according to (3),
wherein the first operation is a region selection operation.
   (5)

The control device according to (4),
wherein the processor is configured to control, based on a region (rectangular area S3) of the third image data selected by the region selection operation, at least one of the imaging direction or a focal length of the imaging apparatus and output image data output from the imaging apparatus in a state of being controlled to the display as the first image data.
   (6)

The control device according to any one of (1) to (5),
wherein the processor is configured to control at least one of the imaging direction or a focal length of the imaging apparatus based on a region selected from the third image data.
   (7)

The control device according to any one of (1) to (6),
wherein the processor is configured to add information (information of rectangular area S3a, rectangular area S3b, and rectangular area S3c) to the third image data, output the information to the display, and acquire the first image data according to the selected information to output the first image data to the display.
   (8)

The control device according to any one of (1) to (7),
wherein the processor is configured to generate the third image data based on an operation (movement operation or enlargement operation of rectangular area S1) of an operation member (reception device 62) and the second image data.
   (9)

The control device according to any one of (1) to (8),
wherein the processor is configured to output, based on an operation of changing the first image data displayed on the display, the first image data after the change and the third image data including image data corresponding to the first image data to the display.
   (10)

The control device according to any one of (1) to (9),
wherein the processor is configured to:
further output the second image data to the display; and
selectively perform first control of outputting the first image data and the third image data to the display and second control of outputting the second image data and the third image data to the display.
   (11)

The control device according to any one of (1) to (10),
wherein the processor is configured to add information indicating an imaging condition of the first image data displayed on the display to the third image data and output the information to the display.
   (12)

The control device according to any one of (1) to (11),
wherein the image data used in the combination for the second image data is a still image, and
the first image data is a video.
   (13)

An imaging control system comprising:
the control device according to any one of (1) to (12); and
the imaging apparatus.
   (14)

A control method comprising:
combining a plurality of pieces of image data obtained by imaging performed by an imaging apparatus whose imaging direction is changeable to generate second image data;
generating third image data, which is different from the second image data, based on the second image data; and
outputting the third image data and first image data obtained by imaging performed by the imaging apparatus to a display.
   (15)

A control program causing a processor to execute steps of:
combining a plurality of pieces of image data obtained by imaging performed by an imaging apparatus whose imaging direction is changeable to generate second image data;
generating third image data, which is different from the second image data, based on the second image data; and
outputting the third image data and first image data obtained by imaging performed by the imaging apparatus to a display.

Various embodiments have been described above, but it goes without saying that the present invention is not limited to such examples. It is apparent that those skilled in the art may perceive various modification examples or correction examples within the scope disclosed in the claims, and those examples are also understood as falling within the technical scope of the present invention. Further, any combination of various components in the embodiment may be used without departing from the gist of the invention.

The present application is based on Japanese Patent Application (JP2022-013396) filed on Jan. 31, 2022, the content of which is incorporated in the present application by reference.

### EXPLANATION OF REFERENCES

1: imaging control system
10: surveillance camera
11: management apparatus
12: communication line
13a: display
13b: keyboard
13c: mouse
14: secondary storage device
15: imaging optical system
15D: imaging optical system drive unit
16: revolution mechanism
19: computer
25: imaging element
25D: imaging element drive unit
31: DSP
32: image memory
34, 66, 67, 68, 79, 80: communication I/F
35, 60C: memory
36, 60B: storage
37, 60A: CPU
38, 70: bus
60: control device
62: reception device
71: yaw-axis revolution mechanism
72: pitch-axis revolution mechanism
73, 74: motor
75, 76: driver
77B, 78B: position sensor
81: image data
82: entire image data
90A, 90B: display region
90: display screen
91: real-time image data
92: partial image data
S1, S2, S3A, S3a, S3b, S3c, S3: rectangular area
W1: frame image data

What is claimed is:

1. A control device comprising:
a processor,
wherein the processor is configured to:
combine a plurality of pieces of image data obtained by imaging performed by an imaging apparatus whose imaging direction is changeable to generate second image data;
generate third image data, which is different from the second image data, based on the second image data;
output the third image data and first image data obtained by imaging performed by the imaging apparatus to a display;
output the second image data to the display; and
selectively perform first control of outputting the first image data and the third image data to the display and second control of outputting the second image data and the third image data to the display.

2. The control device according to claim 1,
wherein the processor is configured to acquire the first image data, based on the third image data, and output the first image data to the display.

3. The control device according to claim 1,
wherein the processor is configured to acquire, based on a first operation on the third image data displayed on the display, the first image data corresponding to the first operation and output the first image data to the display.

4. The control device according to claim 3,
wherein the first operation is a region selection operation.

5. The control device according to claim 4,
wherein the processor is configured to control, based on a region of the third image data selected by the region selection operation, at least one of the imaging direction or a focal length of the imaging apparatus and output, as the first image data, image data output from the imaging apparatus in a state of being controlled to the display.

6. The control device according to claim 1,
wherein the processor is configured to control at least one of the imaging direction or a focal length of the imaging apparatus based on a region selected from the third image data.

7. The control device according to claim 1,
wherein the processor is configured to add information to the third image data, output the information to the display, and acquire the first image data according to the selected information to output the first image data to the display.

8. The control device according to claim 1,
wherein the processor is configured to generate the third image data based on an operation of an operation member and the second image data.

9. The control device according to claim 1,
wherein the processor is configured to output, based on an operation of changing the first image data displayed on the display, the first image data after the change and the third image data including image data corresponding to the first image data to the display.

10. The control device according to claim 1,
wherein the processor is configured to add information indicating an imaging condition of the first image data displayed on the display to the third image data and output the information to the display.

11. The control device according to claim 1,
wherein the image data used in the combination for the second image data is a still image, and
the first image data is a video.

12. An imaging control system comprising:
the control device according to claim 1; and
the imaging apparatus.

13. A control method comprising:
combining a plurality of pieces of image data obtained by imaging performed by an imaging apparatus whose imaging direction is changeable to generate second image data;
generating third image data, which is different from the second image data, based on the second image data;
outputting the third image data and first image data obtained by imaging performed by the imaging apparatus to a display;
outputting the second image data to the display; and
selectively performing first control of outputting the first image data and the third image data to the display and second control of outputting the second image data and the third image data to the display.

14. A non-transitory computer-readable medium storing a control program causing a processor to execute a process, the process comprising:
combining a plurality of pieces of image data obtained by imaging performed by an imaging apparatus whose imaging direction is changeable to generate second image data;
generating third image data, which is different from the second image data, based on the second image data;
outputting the third image data and first image data obtained by imaging performed by the imaging apparatus to a display;
outputting the second image data to the display; and
selectively performing first control of outputting the first image data and the third image data to the display and second control of outputting the second image data and the third image data to the display.
